(19) United States
(12) Patent Application Publication
(10) Pub. No.: US 2026/0088416 A1
(43) Pub. Date: Mar. 26, 2026

(54) BATTERY PACK

(71) Applicant: TOYOTA JIDOSHA KABUSHIKI KAISHA, Toyota-shi (JP)

(72) Inventors: Masataka OGUSHI, Nisshin-shi (JP); Masato MORITAKA, Chiryu-shi (JP); Hiroaki SUEYOSHI, Okazaki-shi (JP)

(73) Assignee: TOYOTA JIDOSHA KABUSHIKI KAISHA, Toyota-shi (JP)

(21) Appl. No.: 19/195,804

(22) Filed: May 1, 2025

(30) Foreign Application Priority Data
Sep. 24, 2024 (JP) 2024-165278

(51) Int. Cl. H01M 50/242; B60L 50/60; B60R 16/033; H01M 50/249; H01M 50/262

(52) U.S. Cl. CPC H01M 50/242; H01M 50/249; H01M 50/262; B60L 50/60; B60L 2200/42; B60R 16/033; H01M 2220/20

(57) ABSTRACT

A battery pack includes a lower case and an upper case having a bending point that is likely to bend when being collided from the front with the battery pack mounted on a vehicle, two battery modules housed inside the lower case and the upper case and disposed in the vehicle front-rear direction to have a gap at the bending point, and an intermediate plate configured to bind and hold the two battery modules. The intermediate plate is provided in the gap.

### CROSS-REFERENCE TO RELATED APPLICATION

This application claims priority to Japanese Patent Application No. 2024-165278 filed on Sep. 24, 2024. The disclosure of the above-identified application, including the specification, drawings, and claims, is incorporated by reference herein in its entirety.

### BACKGROUND

### 1. Technical Field

The disclosure relates to a battery pack including a plurality of battery modules.

### 2. Description of Related Art

Japanese Unexamined Patent Application Publication No. 2019-106258 (JP 2019-106258 A) discloses a structure that is reduced in size and reduces impact on a battery cell in a case where an excessive load is applied from the outside. Specifically, the structure includes a first projecting section, a second projecting section, a first recessed section, and a second recessed section. The first projecting section and the second projecting section each project from a side surface section, and are disposed apart from each other in a predetermined direction. The first projecting section and the second projecting section are respectively fitted into the first recessed section and the second recessed section. A load from the outside is hereby divided between the first projecting section and the second projecting section and it is thus possible to reduce impact on the battery cell.

### SUMMARY

However, in a case where a configuration is adopted in which a lower case and an upper case are included outside the battery cell, the relationship between a position in the lower case and the upper case that is likely to have a collision input and the positions of the first projecting section and the second projecting section is not taken into consideration, so the expected effect may not be obtained in some cases.

An object of the present disclosure is to provide a battery pack that takes the circumstances into consideration and makes it possible to reduce a load on a battery module.

A battery pack according to the present disclosure according to a first aspect includes a lower case and an upper case having a bending point that is likely to bend when being collided from the front with the battery pack mounted on a vehicle, two battery modules housed inside the lower case and the upper case and disposed in the vehicle front-rear direction to have a gap at the bending point, and an intermediate plate configured to bind and hold the two battery modules. The intermediate plate is provided in the gap.

In the battery pack according to the present disclosure according to the first aspect, the intermediate plate is disposed at a portion that seems likely to bend when being collided from the front. The collision input is therefore applied to the intermediate plate, and it is thus possible to reduce a load on the battery modules.

A battery pack according to the present disclosure according to a second aspect has the configuration according to the first aspect in which the bending point may be a changing point at which the width of the battery pack in the vehicle-width direction sharply changes with the battery pack mounted on the vehicle.

When the collision input is applied to the battery pack, the lower case and the upper case are highly likely to bend from a point at which a section in the horizontal direction or the vertical direction sharply changes. In the battery pack according to the present disclosure according to the second aspect, the bending point is the changing point at which the width of the battery pack in the vehicle-width direction sharply changes with the battery pack mounted on the vehicle. It is thus possible to set a point at which the battery pack is highly likely to bend actually as the bending point.

A battery pack according to the present disclosure according to a third aspect has the configuration according to the first or second aspect in which the intermediate plate may include a front holding section configured to bind and hold the battery module on the front side, a rear holding section configured to bind and hold the battery module on the rear side, and a connecting section configured to be more fragile than the front holding section and the rear holding section and connect the front holding section and the rear holding section at the bending point.

The battery pack according to the present disclosure according to the third aspect includes the connecting section configured to be more fragile than the front holding section and the rear holding section at the bending point. The connecting section is therefore broken when a collision input is applied to the intermediate plate, and it is thus possible to reduce a load on the battery modules.

A battery pack according to the present disclosure according to a fourth aspect has the configuration according to the third aspect in which the intermediate plate may have an H-shaped section in a view from at least one of the vehicle-width direction and the vehicle-height direction with the battery pack mounted on the vehicle. The H-shaped section includes the front holding section, the rear holding section, and the connecting section.

In the battery pack according to the present disclosure according to the fourth aspect, the intermediate plate has the H-shaped section including the front holding section, the rear holding section, and the connecting section in a view from at least one of the vehicle-width direction and the vehicle-height direction with the battery pack mounted on the vehicle. The thickness of the connecting section in at least one of the vehicle-width direction and the vehicle-height direction is thus less than the thicknesses of the front holding section and the rear holding section. The connecting section is therefore more fragile than the front holding section and the rear holding section. The connecting section is broken when a collision input is applied to the intermediate plate, and it is therefore possible to reduce a load on the battery modules.

A battery pack according to the present disclosure according to a fifth aspect has the configuration according to any one of the first to fourth aspects in which the two battery modules fastened to the intermediate plate may each be provided with a fastening section at a portion at which the intermediate plate is not present. The fastening section is configured to be fastened to the lower case.

In the battery pack according to the present disclosure according to the fifth aspect, the two battery modules fastened to the intermediate plate each are provided with the fastening section that is fastened to the lower case at the portion at which the intermediate plate is not present. Each of the two battery modules thus remains bound to the lower case even if the intermediate plate is broken.

As described above, a battery pack according to the present disclosure has an excellent effect of making it possible to reduce a load on a battery module.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 includes (A) a schematic longitudinal sectional view and (B) a schematic cross-sectional view of a battery pack according to a first embodiment of the present disclosure;

FIG. 2A is a schematic enlarged view of a main section including a battery module in FIG. 1 before an impact input is applied;

FIG. 2B is a schematic enlarged view of the main section including the battery module in FIG. 1 after the impact input is applied;

FIG. 3 includes (A) a schematic longitudinal sectional view and (B) a schematic cross-sectional view of a battery pack according to a second embodiment of the present disclosure;

FIG. 4 includes (A) a schematic longitudinal sectional view and (B) a schematic cross-sectional view of a battery pack according to a third embodiment of the present disclosure;

FIG. 5 includes (A) a schematic cross-sectional view (with no battery module), (B) a schematic longitudinal sectional view, and (C) a schematic cross-sectional view (with a battery module) of a conventional battery pack; and

FIG. 6 includes (A) a schematic longitudinal sectional view and (B) a schematic cross-sectional view of a conventional battery pack.

### DETAILED DESCRIPTION OF EMBODIMENTS

Hereinafter, a battery pack 10 according to a first embodiment of the present disclosure will be described with reference to the drawings. It is to be noted that the same or equivalent elements will be denoted by the same reference sign and duplicate description will be omitted in the description of the drawings. In addition, the drawings omit duplicate reference signs as appropriate in some cases. In addition, an arrow FR illustrated as appropriate in each of the drawings indicates the front side in the vehicle front-rear direction with the battery pack 10 mounted on a vehicle. An arrow UP indicates the upper side in the vehicle-height direction. An arrow RH indicates the right side in the vehicle-width direction. Hereinafter, unless stated otherwise, description made by simply using the front-rear direction, the height direction, the right-left direction, the inner direction, and the outer direction will indicate the front and rear sides in the vehicle front-rear direction, the upper and lower sides in the vehicle-height direction, the right and left sides in the vehicle right-left direction (vehicle-width direction), and the inner and outer sides in the vehicle-width direction. In addition, the drawings each illustrate the structure of the battery pack schematically and simplify the structure of the battery pack by illustrating even a portion that actually needs hatching, for example, by a thick line.

As an example, the battery pack 10 according to the present embodiment is a secondary battery and is used, for example, for a battery of each kind of vehicle, such as a forklift, a hybrid electric vehicle, and a battery electric vehicle. The battery pack 10 is, for example, a secondary battery, such as a nickel-hydrogen secondary battery or a lithium-ion secondary battery. The battery pack 10 may be, for example, an electric double-layer capacitor.

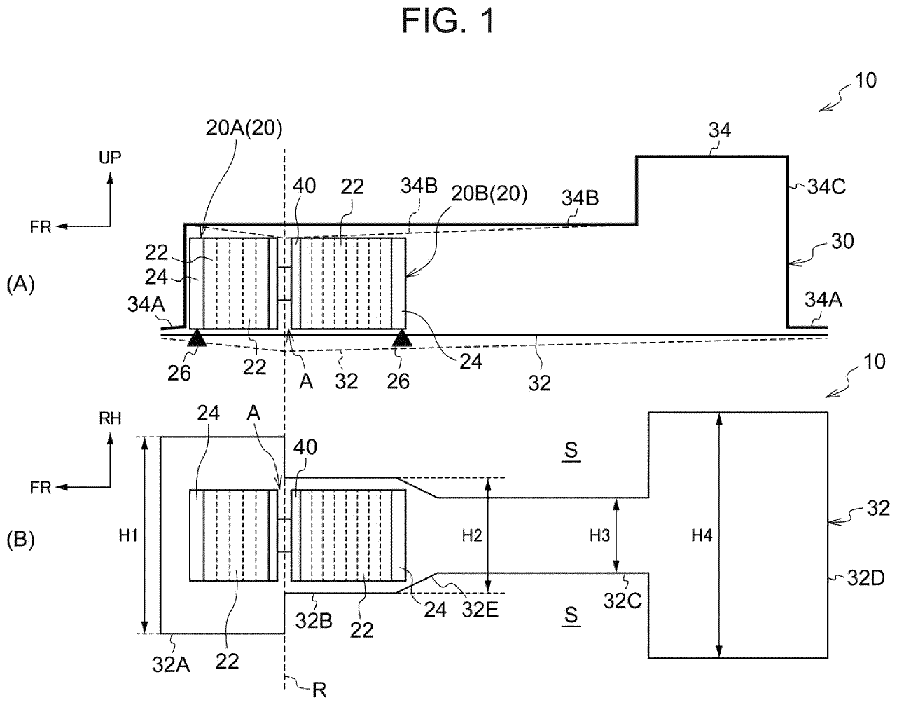

As illustrated in part (A) of FIG. 1, the battery pack 10 includes, as an example, a plurality of battery modules 20, a case 30 that houses the battery modules 20 therein, and an intermediate plate 40 that binds and holds the battery modules 20. In the present embodiment, as an example, the battery pack 10 includes two battery modules 20 of a front battery module 20A and a rear battery module 20B. It is to be noted that any of the front battery module 20A and the rear battery module 20B will be referred to as the battery module 20 in some cases in the following description. Although not illustrated, a plurality of battery modules may be further disposed in a row on the rear side of the rear battery module 20B. The battery modules 20 are electrically connected by a bus bar (not illustrated).

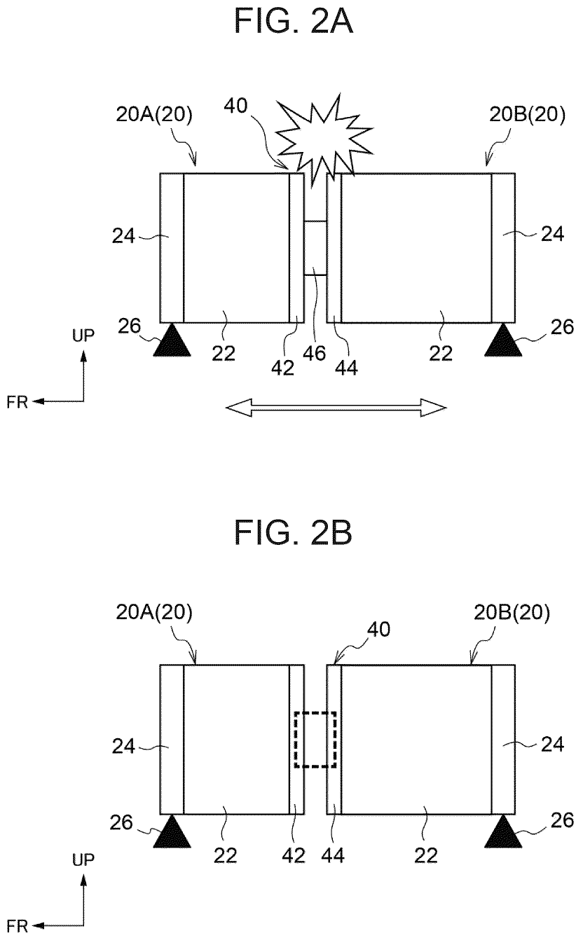

The battery modules 20 each include a plurality of battery cells 22 disposed in a row in one direction. It is to be noted that the number of the battery cells 22 is not limited in particular as long as the number of the battery cells 22 is two or more. In addition, in the present embodiment, the one direction is a direction serving as the vehicle front-rear direction with the battery pack 10 mounted on a vehicle and will be referred to as a stack direction (see a white arrow in FIG. 2A) below.

The case 30 includes a lower case 32 and an upper case 34. As an example, the case 30 includes a high-strength steel plate, a complex including a high-strength steel plate for at least a frame portion and FRGP for the other portions, or the like. As illustrated in part (A) of FIG. 1, the lower case 32 is formed to have a plate shape and allow the battery modules 20 to be placed thereon. The upper case 34 is formed to have a recessed shape the lower portion of which opens. The upper case 34 covers the battery modules 20 from above. The upper case 34 is sealed to the lower case 32.

Further specifically, the upper case 34 includes a flange section 34A at the lower end section. The flange section 34A extends outward and is sealed to the lower case 32. In addition, the upper case 34 includes a front section 34B that rises from the flange section 34A on the vehicle front side and is formed to have a substantially rectangular-parallelepiped shape. The upper case 34 includes a rear section 34C that rises from the flange section 34A on the vehicle rear side, extends from the front section 34B, and is formed to be greater than the front section 34B in height.

The lower case 32 is formed to have a plate shape. The peripheral section thereof is bonded to the flange section 34A of the upper case 34.

As illustrated in part (B) of FIG. 1, the lower case 32 includes a first body section 32A, a second body section 32B, a third body section 32C, and a fourth body section 32D from the vehicle front side. Here, part (B) of FIG. 1 is a schematic cross-sectional view of the battery pack 10, but illustrates that the upper case 34 is detached for the sake of convenience.

The first body section 32A is formed to have a rectangular shape having width H1 in a top view as the width of the first body section in the vehicle-width direction. The second body section 32B is adjacent to the first body section 32A. The second body section 32B has width H2 less than the width of the first body section 32A (H2<H1) in a top view as the width of the second body section in the vehicle-width direction. The second body section 32B includes an oblique side section 32E that gradually grows narrower in width toward the opposite side to the first body section 32A. The third body section 32C is formed to be continuous from the oblique side section 32E in a top view. The third body section 32C is formed to have a rectangular shape having width H3 less than the width of the second body section 32B (H3<H2). The fourth body section 32D is formed to have a rectangular shape having width H4 greater than the width of the first body section 32A (H4>H1) in a top view as the width of the fourth body section in the vehicle-width direction.

The lower case 32 and the upper case 34 each are formed to have the same shape in a top view. In the present embodiment, as an example, the first body section 32A, the second body section 32B, and the third body section 32C of the lower case 32 are covered with the front section 34B of the upper case 34. In addition, the fourth body section 32D of the lower case 32 is covered with the rear section 34C of the upper case 34. It is to be noted that the case 30 is disposed below a floor panel (not illustrated) disposed below a vehicle cabin S in which an occupant gets on as an example in the present embodiment.

When an impact input is applied to the battery pack 10, the case 30 configured as described above, that is, the lower case 32 and the upper case 34, is highly likely to bend from a point at which a section in the horizontal direction or the vertical direction sharply changes. In the present embodiment, as illustrated in part (B) of FIG. 1, the borderline portion between the first body section 32A and the second body section 32B serves as a changing point at which a section in the horizontal direction sharply changes from the width H1 to the width H2. Thus, when an impact input is applied from the front of the vehicle, the lower case 32 and the upper case 34 are highly likely to bend from the changing point. The changing point is therefore used as a bending point R.

Specifically, when an impact input is applied from the front of the vehicle, the lower case 32 is highly likely to bend toward the lower side of the vehicle from the bending point R as illustrated by a dotted line in part (A) of FIG. 1. In addition, the upper case 34 is highly likely to bend toward the lower side of the vehicle from the bending point R as similarly illustrated by a dotted line in part (A) of FIG. 1.

In the case 30 configured as described above, the front battery module 20A and the rear battery module 20B housed in an internal space formed by using the lower case 32 and the upper case 34 are disposed in the vehicle front-rear direction to have a gap A at the bending point R. Specifically, the front battery module 20A is disposed closer to the front of the vehicle than the bending point R and the rear battery module 20B is disposed closer to the rear of the vehicle than the bending point R with the gap A in between.

The intermediate plate 40 that binds and holds the front battery module 20A and the rear battery module 20B is provided in the gap A. As illustrated in FIG. 2A, the intermediate plate 40 includes a front holding section 42 that binds and holds the front battery module 20A and a rear holding section 44 that binds and holds the rear battery module 20B. The front holding section 42 and the rear holding section 44 are connected by a connecting section 46 configured to be more fragile than the front holding section 42 and the rear holding section 44.

The intermediate plate 40 has an H-shaped section including the front holding section 42, the rear holding section 44, and the connecting section 46 in views from the vehicle-width direction and the vehicle-height direction. That is, the connecting section 46 is formed to have smaller diameters in the vehicle-height direction and the vehicle-width direction than the diameters of the front holding section 42 and the rear holding section 44.

In addition, the front battery module 20A and the rear battery module 20B connected by the intermediate plate 40 are sandwiched by a pair of end plates 24 in the vehicle front-rear direction. The end plates 24 each are fastened to the lower case 32 with a bracket or the like in between. Here, portions that fasten the end plates 24 and the lower case 32 each are referred to as a fastening section 26. As illustrated in any of part (A) and part (B) of FIG. 1 and FIG. 2A, the fastening sections 26 are provided at portions at which the intermediate plate 40 is not present. It is to be noted that the width of at least one of each end plate 24 and each fastening section 26 in the vehicle front-rear direction is greater than the widths of the front holding section 42 and the rear holding section 44 in the vehicle front-rear direction to be fastened to the lower case 32 more securely.

Next, the workings and effects of the battery pack 10 according to the first embodiment will be described.

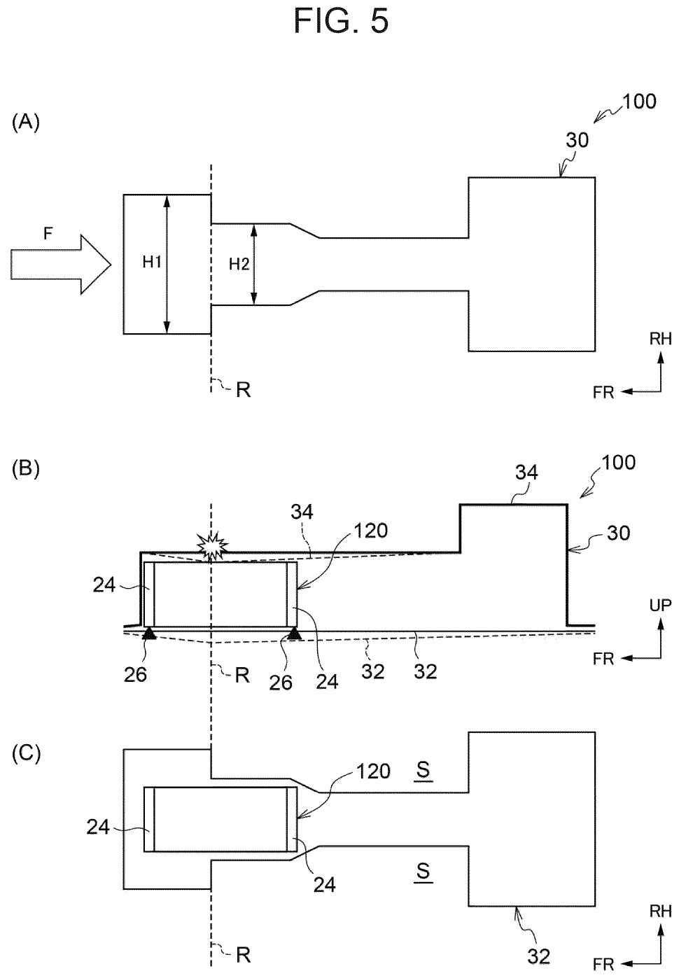

As illustrated in part (A) of FIG. 5, the case 30 having a configuration similar to the configuration in the battery pack 10 according to the embodiment described above is used for a conventional battery pack 100. Here, a component having a configuration similar to the configuration according to the embodiment described above will be denoted by the same reference sign and will not be described in detail below.

When a collision input F is applied to the conventional battery pack 100 from the front, the case 30 is highly likely to bend at the bending point R as illustrated in any of part (B) and part (C) of FIG. 5. To increase the energy density of the conventional battery pack 100, a plurality of battery cells is consecutively disposed in the vehicle front-rear direction in one battery module in the battery pack 100. The battery module is sandwiched between the end plates 24 in the vehicle front-rear direction. The end plates 24 each include the fastening section 26 that is fastened to the lower case 32 with a bracket or the like in between.

In such a conventional structure, when the case 30, that is, the lower case 32 and the upper case 34, bends at the bending point R upon a front collision, the bent lower case 32 and upper case 34 abut the battery module in some cases. A structure that reduces impact on the battery module is necessary.

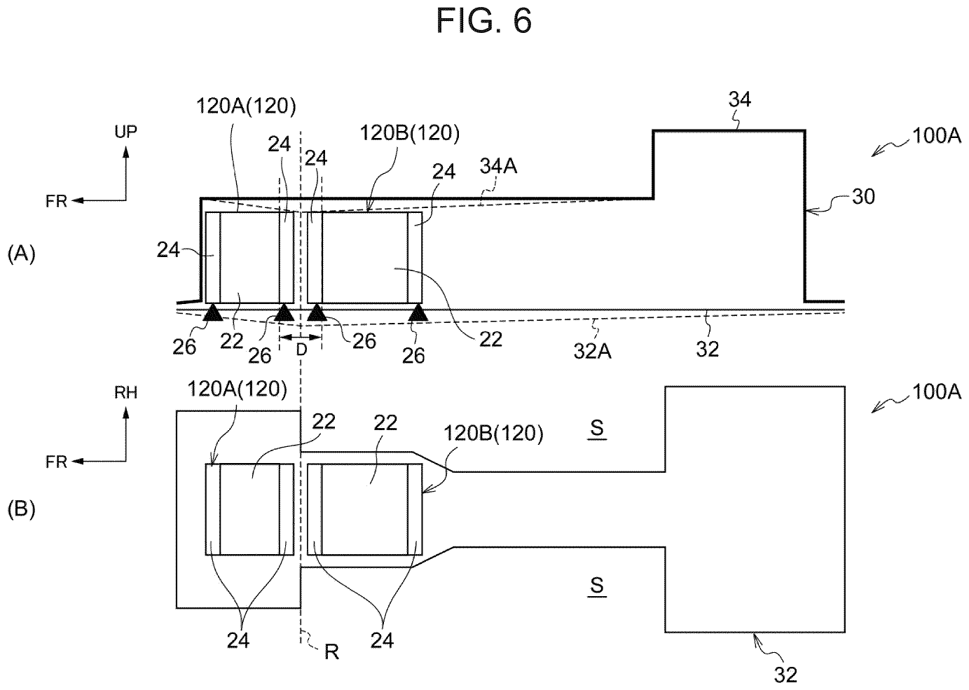

Accordingly, as illustrated in any of part (A) and part (B) of FIG. 6, the battery module is divided in a conventional second battery pack 100A. A front battery module 120A and a rear battery module 120B are disposed in the vehicle front-rear direction to have a gap D at the bending point R. The front battery module 120A and the rear battery module 120B each are then sandwiched between the end plates 24 in the vehicle front-rear direction. The end plates 24 each include the fastening section 26 that is fastened to the lower case 32 with a bracket or the like in between.

Here, the gap D of the conventional second battery pack 100A is set to be greater than the gap A of the battery pack 10 according to the embodiment described above. That is, the end plates 24 are greater than the front holding section 42 and the rear holding section 44 according to the embodiment described above in width in the vehicle front-rear direction. The gap D of the conventional second battery pack 100A in which the two end plates 24 are provided is thus greater than the gap A in which the front holding section 42 and the rear holding section 44 are provided without providing the end plates 24.

It is certainly possible in the conventional second battery pack 100A to reduce impact on battery modules 120 when the case 30, that is, the lower case 32 and the upper case 34, bends at the bending point R upon a front collision. It is, however, necessary to provide both the front battery module 120A and the rear battery module 120B with the end plates 24 and the fastening sections 26 on both sides in the vehicle front-rear direction, resulting in lower energy density.

Accordingly, in the battery pack 10 according to the present embodiment, the intermediate plate 40 is disposed at a portion that seems likely to bend when being collided from the front, that is, in a region including the bending point R. Therefore, when the case 30, that is, the lower case 32 and the upper case 34, bends at the bending point R upon a front collision, the collision input is applied to the intermediate plate 40. It is thus possible to reduce a load on the battery modules 20.

In addition, when a collision input is applied to the battery pack 10, the lower case 32 and the upper case 34 are highly likely to bend from a point at which a section in the horizontal direction or the vertical direction sharply changes. In the battery pack 10 according to the present embodiment, the bending point R is the changing point at which the width of the battery pack 10 in the vehicle-width direction changes more sharply with the battery pack 10 mounted on the vehicle. It is thus possible to set a point at which the battery pack 10 is highly likely to bend actually as the bending point R.

In addition, the battery pack 10 according to the present embodiment includes, at the bending point R, the connecting section 46 configured to be more fragile than the front holding section 42 and the rear holding section 44 of the intermediate plate 40. The connecting section 46 is therefore broken as illustrated in FIG. 2B when a collision input is applied to the intermediate plate 40 as illustrated in FIG. 2A. It is thus possible to reduce a load on the battery modules 20.

In addition, the battery pack 10 according to the present embodiment, the intermediate plate 40 has an H-shaped section including the front holding section 42, the rear holding section 44, and the connecting section 46 in views from the vehicle-width direction and the vehicle-height direction with the battery pack 10 mounted on the vehicle. The thicknesses of the connecting section 46 in the vehicle-width direction and the vehicle-height direction are thus less than the thicknesses of the front holding section 42 and the rear holding section 44. The connecting section 46 is therefore more fragile than the front holding section 42 and the rear holding section 44. The connecting section 46 is broken when a collision input is applied to the intermediate plate 40, and it is therefore possible to reduce a load on the battery modules 20.

In addition, in the battery pack 10 according to the present embodiment, the gap A between the front battery module 20A and the rear battery module 20B in the vehicle front-rear direction is smaller than the gap D of the conventional second battery pack 100A. It is thus possible to restrain the energy density from decreasing in comparison with the conventional second battery pack 100A.

In addition, in the battery pack 10 according to the present embodiment, the front battery module 20A and the rear battery module 20B fastened to the intermediate plate 40 each are provided with the fastening section 26 at a portion at which the intermediate plate 40 is not present. The fastening section 26 is fastened to the lower case 32. Therefore, even if the intermediate plate 40 is broken, the front battery module 20A and the rear battery module 20B each remain bound to the lower case 32.

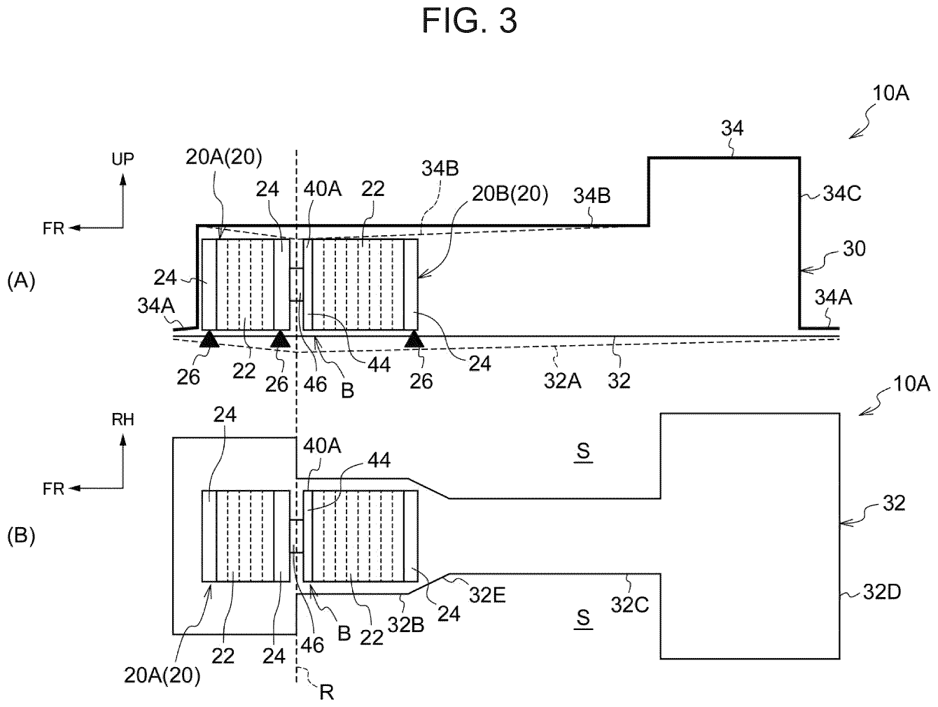

Next, a battery pack 10A according to a second embodiment of the present disclosure will be described with reference to FIG. 3. The battery pack 10A according to the present embodiment includes an intermediate plate 40A having a configuration different from the configuration in the battery pack 10 according to the first embodiment described above. It is to be noted that the components other than the intermediate plate 40A in the present embodiment are similar to the components of the battery pack 10 according to the first embodiment described above and only the intermediate plate 40A will be thus described in detail here.

As illustrated in any of part (A) and part (B) of FIG. 3, the intermediate plate 40A according to the present embodiment does not include a component corresponding to the front holding section 42 of the intermediate plate 40 according to the embodiment. That is, the intermediate plate 40A includes the rear holding section 44 and the connecting section 46.

In the present embodiment, the front battery module 20A is sandwiched between the end plates 24 in the vehicle front-rear direction. The end plates 24 each include the fastening section 26 that is fastened to the lower case 32 with a bracket or the like in between. Of the end plates 24, the end plate 24 on the rear side is bonded to the connecting section 46 of the intermediate plate 40. It is to be noted that the intermediate plate 40A is disposed in a gap B between the front battery module 20A and the rear battery module 20B.

Here, the gap B of the battery pack 10A is set to be greater than the gap A of the battery pack 10 according to the embodiment described above. That is, the end plates 24 are greater than the rear holding section 44 according to the present embodiment in width in the vehicle front-rear direction. The gap B of the battery pack 10A according to the present embodiment in which one end plate 24 is provided is thus greater than the gap A according to the embodiment in which the front holding section 42 and the rear holding section 44 are provided without providing the end plates 24. In contrast, the gap B according to the present embodiment is formed to be smaller than in the conventional second battery pack 100A. That is, the gap B of the battery pack 10A according to the present embodiment in which one end plate 24 is provided is smaller than the gap D of the conventional second battery pack 100A in which the two end plates 24 are provided.

Next, the workings and effects of the battery pack 10A according to the second embodiment will be described.

In the battery pack 10A according to the present embodiment, the intermediate plate 40A is disposed at a portion that seems likely to bend when being collided from the front, that is, in a region including the bending point R as in the embodiment. Therefore, when the case 30, that is, the lower case 32 and the upper case 34, bends at the bending point R upon a front collision, the collision input is applied to the intermediate plate 40A. It is thus possible to reduce a load on the battery modules 20.

In addition, when a collision input is applied to the battery pack 10A, the lower case 32 and the upper case 34 are highly likely to bend from a point at which a section in the horizontal direction or the vertical direction sharply changes. In the battery pack 10A according to the present embodiment, the bending point R is the changing point at which the width of the battery pack 10A in the vehicle-width direction changes more sharply with the battery pack 10A mounted on the vehicle. It is thus possible to set a point at which the battery pack 10A is highly likely to bend actually as the bending point R.

In addition, the battery pack 10A according to the present embodiment includes, at the bending point R, the connecting section 46 configured to be more fragile than the rear holding section 44 of the intermediate plate 40A. The connecting section 46 is therefore broken when a collision input is applied to the intermediate plate 40A. It is thus possible to reduce a load on the battery modules 20.

In addition, in the battery pack 10A according to the present embodiment, the thicknesses of the connecting section 46 of the intermediate plate 40A in the vehicle-width direction and the vehicle-height direction are less than the thicknesses of the rear holding section 44 in views from the vehicle-width direction and the vehicle-height direction with the battery pack 10A mounted on a vehicle. The connecting section 46 is therefore more fragile than the rear holding section 44. The connecting section 46 is broken when a collision input is applied to the intermediate plate 40A, and it is therefore possible to reduce a load on the battery modules 20.

In addition, in the battery pack 10A according to the present embodiment, the front battery module 20A is sandwiched between the end plates 24 in the vehicle front-rear direction. The end plates 24 each include the fastening section 26 that is fastened to the lower case 32 with a bracket or the like in between. The gap B between the front battery module 20A and the rear battery module 20B is therefore greater than the gap A according to the embodiment. It is, however, possible to make the gap B between the front battery module 20A and the rear battery module 20B smaller than the gap A of the conventional second battery pack 100A. It is thus possible to restrain the energy density from decreasing in comparison with the conventional second battery pack 100A.

In addition, in the battery pack 10A according to the present embodiment, the front battery module 20A and the rear battery module 20B fastened to the intermediate plate 40A each are provided with the fastening section 26 at a portion at which the intermediate plate 40A is not present. The fastening section 26 is fastened to the lower case 32. Therefore, even if the intermediate plate 40A is broken, the front battery module 20A and the rear battery module 20B each remain bound to the lower case 32.

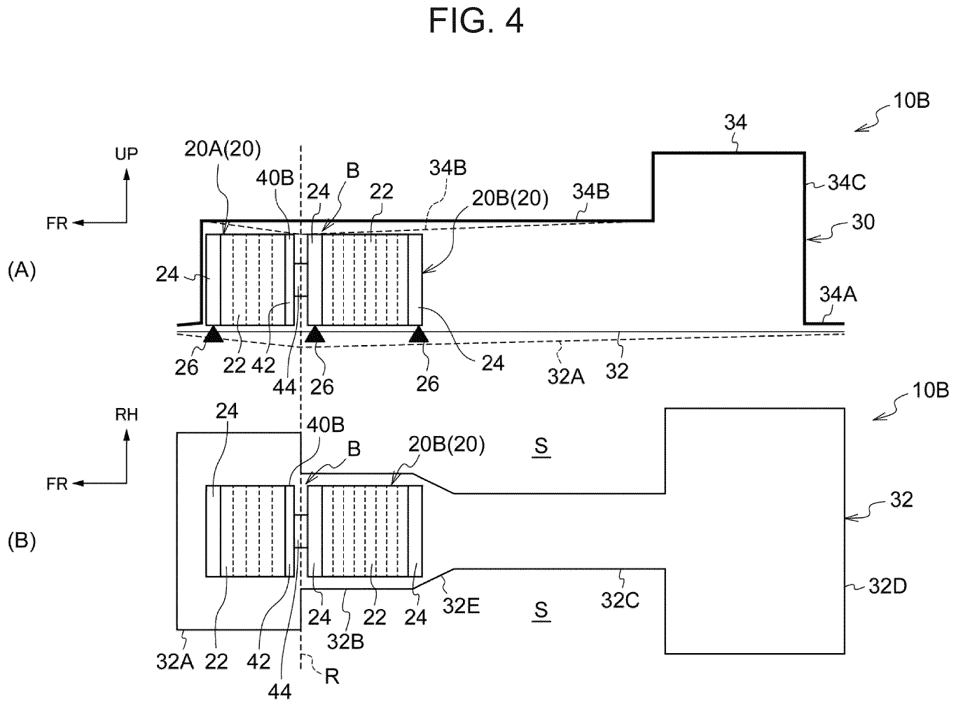

Next, a battery pack 10B according to a third embodiment of the present disclosure will be described with reference to FIG. 4. The battery pack 10B according to the present embodiment includes an intermediate plate 40B having a configuration different from the configuration in the battery pack 10 according to the first embodiment described above. It is to be noted that the components other than the intermediate plate 40B in the present embodiment are similar to the components of the battery pack 10 according to the first embodiment described above and only the intermediate plate 40B will be thus described in detail here.

As illustrated in any of part (A) and part (B) of FIG. 4, the intermediate plate 40B according to the present embodiment does not include a component corresponding to the rear holding section 44 of the intermediate plate 40 according to the embodiment. That is, the intermediate plate 40B includes the front holding section 42 and the connecting section 46.

The present embodiment is different from the second embodiment described above and the rear battery module 20B is sandwiched between the end plates 24 in the vehicle front-rear direction and the end plates 24 each include the fastening section 26 that is fastened to the lower case 32 with a bracket or the like in between. Of the end plates 24, the end plate 24 on the rear side is bonded to the connecting section 46 of the intermediate plate 40. It is to be noted that the intermediate plate 40B is disposed in the gap B between the front battery module 20A and the rear battery module 20B. Here, the gap B of the battery pack 10B is set as with the gap B of the battery pack 10A according to the second embodiment described above.

Next, the workings and effects of the battery pack 10B according to the third embodiment will be described.

The present embodiment is different from the second embodiment in that the battery pack 10B according to the present embodiment includes the end plate 24 for the rear battery module 20B in the gap B while the battery pack 10A according to the second embodiment includes the end plate 24 for the front battery module 20A. The present embodiment is, however, similar to the second embodiment in other respects. It is therefore possible to obtain effects similar to the effects of the second embodiment.

### Supplementary Description

It is to be noted that the intermediate plate 40 has H-shaped sections in views from the vehicle-width direction and the vehicle-height direction with the battery pack mounted on a vehicle in the first embodiment described above, but the present disclosure is not limited to this. For example, the intermediate plate 40 may have an H-shaped section in a view from the vehicle-width direction or the vehicle-height direction alone with the battery pack mounted on a vehicle.

In addition, in the embodiments described above, the connecting sections 46 of the intermediate plates 40, 40A, 40B are formed to have smaller diameters in the vehicle-height direction and the vehicle-width direction than the diameters of the front holding section 42 and the rear holding sections 44, but the present disclosure is not limited to this. The diameter in the vehicle-height direction or the vehicle-width direction may be formed to be larger.

It is to be noted that the intermediate plates 40, 40A, 40B are not limited to the structures as long as the connecting section 46 is configured to be more fragile than the front holding section and the rear holding section. For example, the connecting section may be provided with a fragile section, such as a slit or a notch.

In addition, the configurations according to the present disclosure are not limited to the embodiments. As long as it is possible to solve the problem, it is possible to modify the configurations as appropriate.

What is claimed is:

1. A battery pack comprising:
a lower case and an upper case having a bending point that is likely to bend when being collided from front with the battery pack mounted on a vehicle;
two battery modules housed inside the lower case and the upper case and disposed in a vehicle front-rear direction to have a gap at the bending point; and
an intermediate plate configured to bind and hold the two battery modules, the intermediate plate being provided in the gap.

2. The battery pack according to claim 1, wherein the bending point is a changing point at which a width of the battery pack in a vehicle-width direction sharply changes with the battery pack mounted on the vehicle.

3. The battery pack according to claim 1, wherein the intermediate plate includes
a front holding section configured to bind and hold the battery module on a front side,
a rear holding section configured to bind and hold the battery module on a rear side, and
a connecting section configured to be more fragile than the front holding section and the rear holding section and connect the front holding section and the rear holding section at the bending point.

4. The battery pack according to claim 3, wherein the intermediate plate has an H-shaped section in a view from at least one of a vehicle-width direction and a vehicle-height direction with the battery pack mounted on the vehicle, the H-shaped section including the front holding section, the rear holding section, and the connecting section.

5. The battery pack according to claim 1, wherein the two battery modules bound and held by the intermediate plate each are provided with a fastening section at a portion at which the intermediate plate is not present, the fastening section being configured to be fastened to the lower case.
